(19) United States
(12) Patent Application Publication
(10) Pub. No.: US 2025/0237754 A1
(43) Pub. Date: Jul. 24, 2025

(54) SYSTEMS AND METHODS FOR ULTRASONIC CHANNEL COEXISTENCE

(71) Applicant: InvenSense, Inc., San Jose, CA (US)

(72) Inventors: Joe Youssef, Noyarey (FR); Agnes Gomez, Grenoble (FR); Richard J. Przybyla, Piedmont, CA (US); Mitchell Kline, Alameda, CA (US)

(21) Appl. No.: 18/983,586

(22) Filed: Dec. 17, 2024

Related U.S. Application Data
(60) Provisional application No. 63/624,322, filed on Jan. 24, 2024.

(51) Int. Cl. G01S 7/52; G01S 7/527; G01S 15/87

(52) U.S. Cl. CPC G01S 7/52001; G01S 7/5273; G01S 15/87

(57) ABSTRACT

Multiple ultrasonic sensors operate within a shared space such that each ultrasonic sensor receives, in addition to reflections of its own broadcast signal, broadcast signals from other sensors. The ultrasonic sensors encode information about their respective broadcast signals, such as timing of broadcasts and pulse patterns, within their broadcast signals. The ultrasonic sensors utilize this information to avoid or limit receiving broadcast signals from other sensors during their respective receive windows. The ultrasonic sensors may also scan a channel to identify other sensors and their broadcast characteristics, and from that information, select and optimize their own broadcast characteristics.

### CROSS-REFERENCE TO RELATED APPLICATION

This application claims priority to U.S. Provisional Patent Application No. 63/624,322, filed Jan. 24, 2024, and entitled “ULTRASONIC CHANNEL AUTO CONFIG,” which is incorporated by reference herein in its entirety for all purposes.

### BACKGROUND

Object detection systems are integrated into numerous end use devices such as security systems, door locks, computers, smart phones, tablet devices, vehicles, and the like. In many such applications, the device that includes the object detection system is not connected to a continuous power supply such as an electrical outlet, but instead is powered by a battery or other intermittent power source. In some applications, the object detection system is only needed occasionally or intermittently, such that continuously or periodically powering certain components of the object detection system such as an image capture system (e.g., an image, infrared or time-of-flight camera) and associated processing circuitry results in substantial unnecessary power consumption.

Ultrasonic sensors such as a piezoelectric micromachined ultrasonic transducer (“PMUT”) sensor broadcast an ultrasound signal or wave into an environment of interest and measure reflected signals that are received over time, with the timing and magnitude of the reflected or echo signal corresponding to the distance to an object of interest and the characteristics of the object causing the reflection. The ultrasound signals can be rebroadcasted over a period of time and in a predetermined timing pattern as is useful to capture information of interest, such as movement of objects which can be extracted from changing reflections over time. This information can in turn be used to make determinations about the objects, such as a type of object or a characterization of the object's movement or status. As ultrasonic sensors are employed in ever more applications, and multiple ultrasonic sensors are used in end-use applications, broadcasted signals from multiple ultrasonic sensors may interfere with each other, creating confusion with reflections of objects to be sensed.

### SUMMARY

In some embodiments, a method of operating an ultrasonic sensor within a multi-sensor environment comprises broadcasting, by the ultrasonic sensor, a first ultrasonic signal at each of a plurality of broadcast times, wherein the first ultrasonic signal includes a first encoded identifier and receiving, by the ultrasonic sensor, received ultrasonic signals during a plurality of receive windows, wherein each receive window of the plurality of receive windows follows a respective broadcast time of the plurality of broadcast times. The method further comprises identifying a second ultrasonic signal from the received ultrasonic signals based on a respective timing of the second ultrasonic signal and the first ultrasonic signal, wherein the second ultrasonic signal includes a second encoded identifier, and wherein the respective timing is based on a first timing of broadcasts of the first ultrasonic signal indicated by the first identifier and a second timing of broadcasts of the second ultrasonic signal indicated by the second identifier. The method further comprises monitoring an object within a field of view of the ultrasonic signal based on a subset of the received ultrasonic signals that does not include the second ultrasonic signal.

In some embodiments, a method of operating an ultrasonic sensor within a multi-sensor environment comprises monitoring, by a first ultrasonic sensor, for received ultrasonic signals and identifying, from the received ultrasonic signals, a plurality of broadcasts from a plurality of additional ultrasonic sensors The method further comprises determining, from the received ultrasonic signals, a subset of occupied channels of a plurality of broadcast channels, wherein each channel of the plurality of broadcast channels is associated with a unique fixed delay between broadcasts. The method further comprises selecting, based on the subset of occupied channels, another of the broadcast channels for the first ultrasonic signal and broadcasting ultrasonic signals from the first ultrasonic in accordance with the selected broadcast channel.

In some embodiments, an ultrasonic sensor configured to operate within a multi-sensor environment comprises an ultrasonic transceiver configured to broadcast and receive ultrasonic signals and processing circuitry coupled to the transceiver, wherein the processing circuitry is configured to broadcast, via the transceiver, a first ultrasonic signal at each of a plurality of broadcast times, wherein the first ultrasonic signal includes a first encoded identifier. The processing circuitry is further configured to receive, via the transceiver, received ultrasonic signals during a plurality of receive windows, wherein each receive window of the plurality of receive windows follows a respective broadcast time of the plurality of broadcast times, and identify a second ultrasonic signal from the received ultrasonic signals based on a respective timing of the second ultrasonic signal and the first ultrasonic signal, wherein the second ultrasonic signal includes a second encoded identifier, and wherein the respective timing is based on a first timing of broadcasts of the first ultrasonic signal indicated by the first identifier and a second timing of broadcasts of the second ultrasonic signal indicated by the second identifier. The processing circuitry is further configured to monitor an object within a field of view of the ultrasonic signal based on a subset of the received ultrasonic signals that does not include the second ultrasonic signal.

### BRIEF DESCRIPTION OF DRAWINGS

The above and other features of the present disclosure, its nature, and various advantages will be more apparent upon consideration of the following detailed description, taken in conjunction with the accompanying drawings in which:

FIG. 1 depicts an illustrative sensor system including an ultrasonic sensor in accordance with an embodiment of the present disclosure;

FIG. 2A depicts an object detection system in which interference can occur when two ultrasonic sensors are in use in accordance with an embodiment of the present disclosure;

FIG. 2B shows in greater detail interference between the ultrasonic sensors shown in FIG. 2A in accordance with an embodiment of the present disclosure;

FIG. 3 depicts the use of random time hopping with multiple sensors to limit interference of ultrasonic signals in accordance with an embodiment of the present disclosure;

FIG. 4 depicts an illustrative object detection system with programmable delays of ultrasonic transmissions in accordance with an embodiment of the present disclosure;

FIG. 5A depicts an illustrative object detection system with ultrasonic sensors wherein a sensor monitors transmissions to join a network of sensors in accordance with an embodiment of the present disclosure;

FIGS. 5B and 5C depict a sensor utilizing the monitoring to determine availability of ultrasonic transmission channels in accordance with an embodiment of the present disclosure;

FIG. 6 depicts exemplary steps of ultrasonic channel autoconfiguration in accordance with an embodiment of the present disclosure; and

FIG. 7 depicts an exemplary sequence of signals for ultrasonic channel configuration in accordance with an embodiment of the present disclosure.

### DETAILED DESCRIPTION

Ultrasonic sensors such as PMUT sensors include an ultrasonic transceiver (e.g., one or more components that alone or in combination create and broadcast acoustic signals based on electrical signals and create electrical signals based one received acoustic signals such as reflections of the broadcast signals) and broadcast acoustic signals into an area of interest. In many applications the ultrasonic transceiver (e.g., in some embodiments the same ultrasonic component(s) that broadcast, and/or in other embodiments, one or more other ultrasonic components) receives reflections of the broadcasted signal, with the timing of the reflections corresponding to the time it takes for the broadcast ultrasonic signal to reflect from an object within the area of interest. Repeated broadcast/receive cycles can identify whether and how an object is moving within the area of interest.

Multiple ultrasonic sensors may be located within a common area of interest, for example, as part of a common monitoring system, where ultrasonic sensors are used for multiple end use applications in a single environment, or where an ultrasonic sensor is present on a device that moves or is capable of being moved. In accordance with the present disclosure, a variety of techniques are utilized to eliminate or substantially limit instances where a broadcast signal from one ultrasonic sensor is received within the receive window of another ultrasonic sensor within the environment. Each ultrasonic sensor broadcasts its ultrasonic signal according to a predetermined pattern that provides encoding of characteristics of the broadcast signal. Encoding can be based on a variety of controllable broadcast parameters such as a delay between multiple pulses, signal amplitudes, signal duty cycles, other controllable patterns, and combinations thereof. This encoding, in turn, can be used to look up and/or derive the broadcast characteristics for the particular ultrasonic sensor.

The ultrasonic sensors can utilize their knowledge of other ultrasonic sensor broadcast characteristics to improve coexistence within the common area of interest. Each sensor can “know” when other ultrasonic sensors are likely to interfere with a reflection of interest, and ignore or filter received signals during those known times to remove or otherwise mitigate the received signal due to another ultrasonic sensor broadcast. Broadcast and receive periods can be skipped where it is known that there is likely to be interfering broadcast signals, saving on power consumption where useful information is unlikely to be received. The timing (e.g., phase) of broadcasts can be modified or staggered to avoid receiving other broadcast signals, as can the frequency (e.g., period between transmissions) so that ultrasonic sensor broadcasts and desired reflections are highly unlikely to overlap. This can be implemented as multiple ultrasonic “channels” each having a distinct frequency, with the relative frequencies and phases dynamically selected to minimize interference. Devices can implement a scanning technique when they are set up in a new area, or occasionally after set up, to identify channels that are “taken” within an environment and select a channel for operation that is least likely to result in interference with other ultrasonic broadcasts.

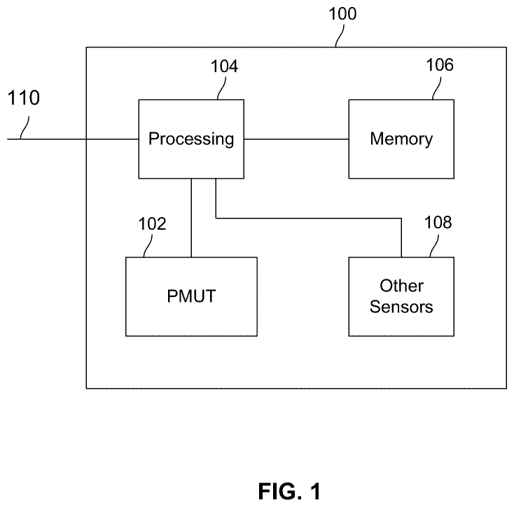

FIG. 1 shows an illustrative ultrasonic sensor system 100 in accordance with an embodiment of the present disclosure. Although particular components are depicted in FIG. 1, it will be understood that other suitable combinations of ultrasonic sensors, other sensors (e.g., MEMS or pressure sensors) processing components, memory, and other circuitry may be utilized as necessary for different applications and systems. In accordance with the present disclosure, the ultrasonic sensor system may include a PMUT first ultrasonic sensor02 as well as additional sensors 108. Although the present disclosure will be described in the context of signals received from certain ultrasonic sensor designs and configurations, it will be understood that the channel monitoring and autoconfiguration techniques may be utilized for a variety of underlying ultrasonic sensor types, for example, assuming that the ultrasonic sensor is capable of modifying characteristics of broadcasted signals such as to encode channel definitions and transmission characteristics (e.g., period, etc.).

Processing circuitry 104 may include one or more components providing processing based on the requirements of the ultrasonic sensor system 100. In some embodiments, processing circuitry 104 may include hardware control logic that may be integrated within a chip of a sensor (e.g., of a die of a PMUT 102 or other sensors 108, or on an adjacent portion of a chip to the PMUT 102 or other sensors 108) to control the operation of the PMUT 102 or other sensors 108 and perform aspects of processing for the PMUT 102 or the other sensors 108. In some embodiments, the PMUT 102 and other sensors 108 may include one or more registers that allow aspects of the operation of hardware control logic to be modified (e.g., by modifying a value of a register). In some embodiments, processing circuitry 104 may also include a processor such as a microprocessor that executes software instructions, e.g., that are stored in memory 106. The microprocessor may control the operation of the PMUT 102 by interacting with the hardware control logic and processing signals received from PMUT 102. The microprocessor may interact with other sensors 108 in a similar manner. In some embodiments, some or all of the functions of the processing circuitry 104, and in some embodiments, of memory 106, may be implemented on an application specific integrated circuit (“ASIC”) and/or a field programmable gate array (“FPGA”), for example, within a back cavity of the ultrasonic sensor.

Although in some embodiments (not depicted in FIG. 1), the PMUT 102 or other sensors 108 may communicate directly with external circuitry (e.g., via a serial bus or direct connection to sensor outputs and control inputs), in an embodiment the processing circuitry 104 may process data received from the PMUT 102 and other sensors 108 and communicate with external components via a communication interface 110 (e.g., a serial peripheral interface (SPI) or I2C bus, in automotive applications a controller area network (CAN) or Local Interconnect Network (LIN) bus, or in other applications a suitably wired or wireless communications interface as is known in the art). The processing circuitry 104 may convert signals received from the PMUT 102 and other sensors 108 into appropriate measurement units (e.g., based on settings provided by other computing units communicating over the communication interface 110).

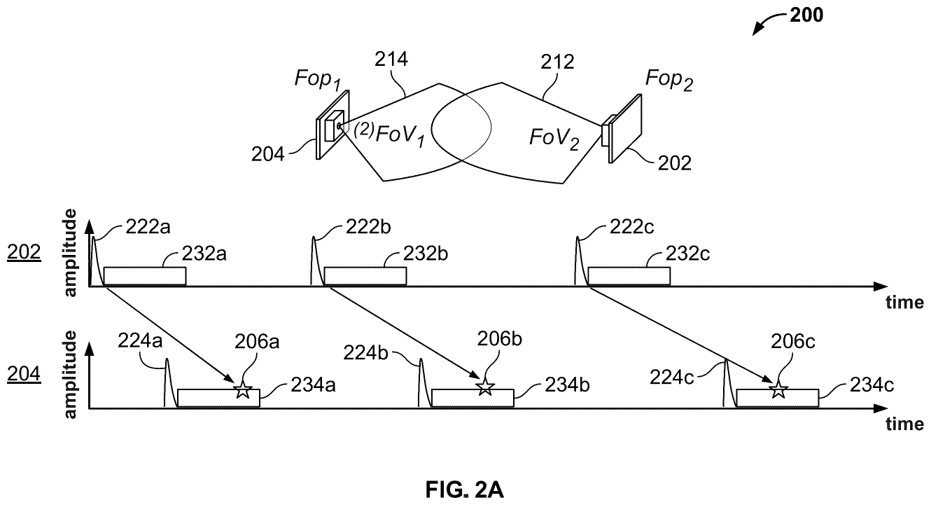

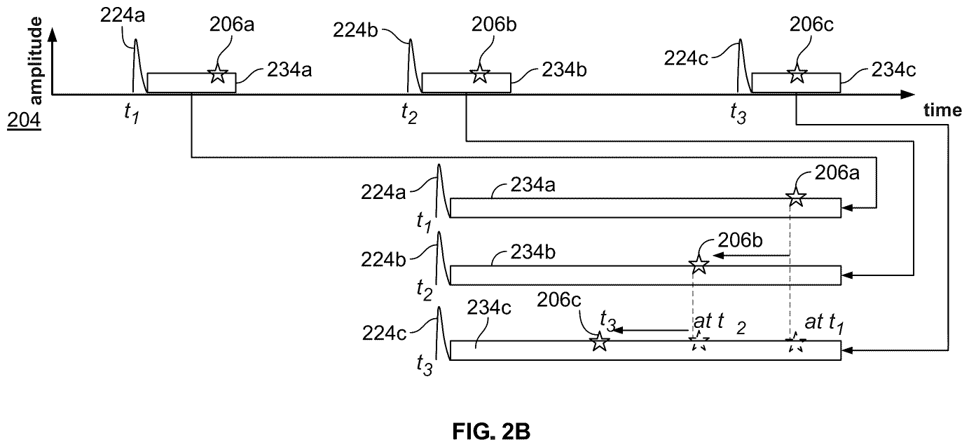

FIG. 2A shows an object detection system 200 where interference can occur when two ultrasonic sensors are in use in accordance with an embodiment of the present disclosure. FIG. 2A shows a first ultrasonic sensor and a second ultrasonic sensor at particular locations including a common area of interest. It will be understood that the particular orientation, location, and number of ultrasonic sensors is for illustration only and that in accordance with the present disclosure numerous ultrasonic sensors (e.g., 3, 4, 10, dozens, etc.) may be located at multiple relative locations and orientations. In the embodiment of FIG. 2A, first second ultrasonic sensor 202 has a field of view 212 (shown as FoV₁) and broadcasts at a certain ultrasonic sensor operation frequency Fop₁, while second ultrasonic second ultrasonic sensor 204 has a field of view 214 (shown as FoV₂) and operates at a certain sensor operation frequency Fop₂. Each of these two fields of view 212 and 214 (FoV₁ and FoV₂) include an overlapping or shared area of interest as depicted in FIG. 2, e.g., where the timing of the receive window to receive reflections of a broadcast will be monitored. Because of this overlap, depending on the timing of the broadcast signal of the other ultrasonic signal 202 or 204, a broadcast ultrasonic signal from the other ultrasonic sensor may be received while the ultrasonic sensor is monitoring for reflections, with this “overlap” creating interference when the first ultrasonic sensor 202 and second ultrasonic sensor 204 operate at the same or similar times (e.g., in view of expected reflection times for a monitoring window and time for a broadcast acoustic signal from another ultrasonic sensor to travel between acoustic sensors, including via reflections).

FIG. 2A depicts a timing diagram showing relative timing of broadcasts (e.g., depicted as pulses), monitoring periods for reflections (e.g., depicted as rectangles that follow a broadcast pules), and interference (e.g., depicted as “stars” within monitoring periods, and with arrowed lines associating the broadcast pulse with the time in transit to the other ultrasonic sensor during its monitoring period. It will be understood that these depictions are provided for illustration only, and that each of the broadcast signal, monitoring period, relative timing of transmissions, timing of interference, and other aspects of FIG. 2A will be different depending on ultrasonic sensor type, location, configuration, and the like.

As depicted in FIG. 2A for first ultrasonic sensor 202, first ultrasonic sensor 202 emits a first broadcast pulse 222a at time equals 0, a second broadcast pulse 222b at a time 0+1n and a third broadcast pulse 222c at time equals 0+2n, wherein “n” represents a period between broadcasts from first ultrasonic sensor 202. After first ultrasonic sensor 202 emits each broadcast pulse 222, a corresponding second receive window 232 opens to receive reflections of the respective broadcast pulse, with the timing of the opening of the receive window and the monitoring period of the receive window based on the ultrasonic signal strength (e.g., corresponding to area covered), the expected location of objects to be monitored, user settings, etc. As depicted in FIG. 2A, first ultrasonic sensor 202 emits first broadcast pulse 222a and thereafter monitors reflections during a first receive window 232a, emits second broadcast pulse 222b and thereafter monitors reflections during a second receive window 232b, and emits third broadcasts pulse 222c reflections during a second receive window 232c.

In a similar fashion, second ultrasonic sensor 204 emits broadcast pulses 224 and thereafter monitors reflections during a receive windows and 234. More specifically, second ultrasonic sensor 204 emits a first broadcast pulse 224a at time 0⁺, a second broadcast pulse 224b at time 0⁺+1m, a third broadcast pulse 224c at time equals 0⁺+2m, where 0⁺ represents a time difference after the initial broadcast 222a from first ultrasonic sensor 202 and the initial broadcast 224a from second ultrasonic sensor 204, and wherein “m” represents a period between broadcasts form first ultrasonic sensor 202 After second ultrasonic sensor 202 emits each broadcast pulse 224, a corresponding second receive window 234 opens to receive reflections of the respective broadcast pulse, with the timing of the opening of the receive window and the monitoring period of the receive window based on the ultrasonic signal strength (e.g., corresponding to area covered), the expected location of objects to be monitored, user settings, etc. As depicted in FIG. 2A, first ultrasonic sensor 203 emits first broadcast pulse 224a and thereafter monitors reflections during a first receive window 234a, emits second broadcast pulse 242b and thereafter monitors reflections during a second receive window 234b, and emits third broadcasts pulse 224c reflections during a second receive window 234c.

FIG. 2A further shows interference 206 that second ultrasonic sensor 204 receives based on the broadcasts from first ultrasonic sensor 202. More specifically, when first ultrasonic sensor 202 emits first broadcast pulse 222a, second ultrasonic sensor 204 sees it in its first receive window 234a as interference 206a, when first ultrasonic sensor 202 emits second broadcast pulse 222b, second ultrasonic sensor 204 sees it in its sensor receive window 234b as interference 206b, and when first ultrasonic sensor 202 emits third broadcast pulse 222c, second ultrasonic sensor 204 sees it in its third receive window 234c as interference 206c. When interference 206 occurs as shown in FIG. 2A, the interference may be perceived by the second ultrasonic sensor 204 as a reflection or may be interpreted as noise that interferes with a reflection of broadcast from second ultrasonic sensor 204. In this manner, the interfering signal may result in false positives (e.g., object identification), false negatives (e.g., failing to identify an object), or other incorrect results (e.g., misinterpreting movement of an object over multiple receive windows).

FIG. 2B shows in greater detail the interference viewed by a second sensor 204 from a first sensor 202 as shown in FIG. 2A in accordance with an embodiment of the present disclosure. FIG. 2B shows second ultrasonic sensor 204, its broadcast pulses 224 and the interference it views 206 created from the broadcast pulses 222 of first ultrasonic sensor 202. In FIG. 2B at t₁ second ultrasonic sensor 204 emits first broadcast pulse 224a of second ultrasonic sensor at time equals 0⁺. As shown in FIG. 2B, t₁ is at a time after first broadcast pulse 222a of first ultrasonic sensor 202. (i.e., if first broadcast pulse 222a of first ultrasonic sensor 202 emits at time 0, then the second broadcast pulse 224a of second ultrasonic sensor 204 emits at a time after 0, herein referred as 0⁺ and referred to as t₁ in FIG. 2B). Based on the respective timing of the broadcasts from the first ultrasonic sensor 202 and the second ultrasonic sensor 204, second ultrasonic sensor 204 has its receive windows 234 open and can receive the broadcast pulses of first ultrasonic sensor 202 in its sensor receive windows 234. In the embodiment of FIGS. 2A and 2B, the first ultrasonic sensor 202 and second ultrasonic sensor 204 have different periods between broadcasts and receive windows, and thus the interference 206 is perceived by the second ultrasonic sensor 204 as a “moving” object.

For example, at t₁ (0⁺), second ultrasonic sensor 204 emits first broadcast pulse 224a. Thereafter, first receive window 234a is open and receives the first broadcast pulse of first ultrasonic sensor 222a which is represented by interference 206a. At t₂ (0⁺+1m), second ultrasonic sensor 204 emits second broadcast pulse 224b. Thereafter, the second receive window 234b of second ultrasonic sensor 204 is open and receives the second broadcast pulse of first ultrasonic sensor 222b which is represented by interference 206b. At t₃ (0⁺+2m), second ultrasonic sensor 204 emits third broadcast pulse 224c. Thereafter, the third receive window 234c of second ultrasonic sensor 204 is open and receives third broadcast pulse of first ultrasonic sensor 222c which is represented by interference 206c.

FIG. 2B further shows that interference 206 is shown closer and closer in time to the beginning of the opening of each sensor receive window of second ultrasonic sensor 234 (i.e., interference 206a from first broadcast pulse 222a of first ultrasonic sensor 202 is shown being viewed towards the end of the receiving time of first receive window 234a, interference 206b from second broadcast pulse 222b of first ultrasonic sensor 202 is shown being viewed in somewhat closer to the beginning of receive window 234b, and interference 206c from third broadcast pulse 222c of first ultrasonic sensor 202 is shown being viewed further closer to the beginning of third receive window 234c. As a result, it appears that interference 206 resembles an object moving closer to second ultrasonic sensor 204 over time.

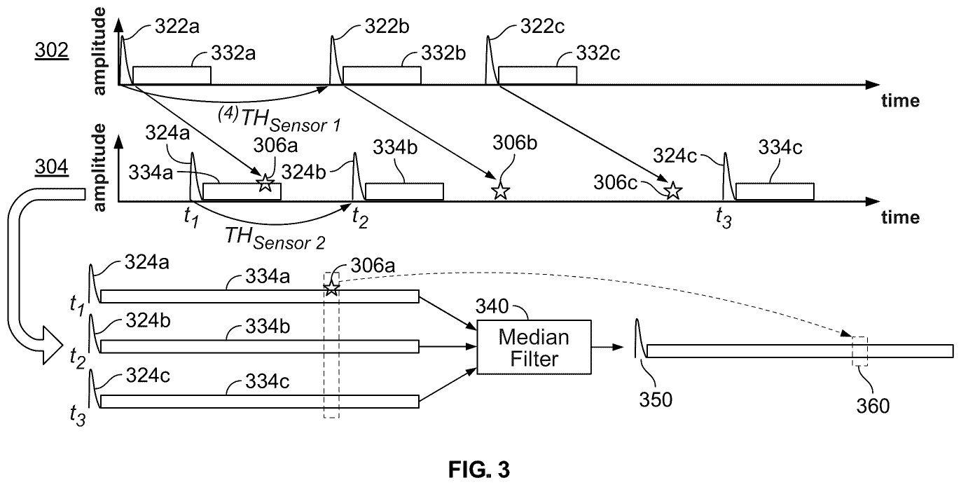

FIG. 3 depicts the use of random time hopping with multiple sensors to limit interference of ultrasonic signals in accordance with an embodiment of the present disclosure. FIG. 3 shows a first ultrasonic sensor 302 and a second ultrasonic sensor 304. Both sensors 302, 304 emit pulses at changing (e.g., random) time intervals to reduce periodic overlap. First ultrasonic 302 emits ultrasonic pulses 322 at changing time intervals, for example, with a first broadcast pulse 322a at time equals 0, a second broadcast pulse 322b at a time equals 0+TH_{Sensor1}, and a third broadcast pulse 322c at a time after 0+TH_{Sensor1}. A first receive window 332a of first ultrasonic sensor 302 opens after first pulse 322a is broadcast, a second receive window 332b of first ultrasonic sensor 302 opens after second pulse 322b is broadcast, and a third receive window 332b of first ultrasonic sensor 302 opens after third pulse 322c is broadcast.

Similarly, second ultrasonic sensor 304 emits ultrasonic pulses 324 at changing time intervals, and with different changes than first ultrasonic sensor 302, for example, with a first broadcast pulse 324a at time equals 0, a second broadcast pulse 324b at a time equals 0+TH_{Sensor2}, and a third broadcast pulse 324c at a time after 0+TH_{Sensor2}. A first receive window 334a of second ultrasonic sensor 304 opens after first pulse 324a is broadcast, a second receive window 334b of second ultrasonic sensor 304 opens after second pulse 324b is broadcast, and a third receive window 334b of second ultrasonic sensor 304 opens after third pulse 324c is broadcast.

FIG. 3 further shows the broadcast pulses of first ultrasonic sensor 302 as potential interference that can be viewed by second ultrasonic sensor 304. First broadcast pulse 322a of the first ultrasonic sensor 302 is emitted at a time when the sensor first receive window 334a of second ultrasonic sensor 304 is open. Thus, second ultrasonic sensor 304 views this broadcast pulse 322a as interference 306a. Because of the random time intervals of the pulses of both sensors 302, 304, both second broadcast pulse 322b of first ultrasonic 302 and third broadcast pulse 322c of first ultrasonic 302 are emitted at times when the sensor receive windows (e.g., 324b and 324c) of second ultrasonic third sensor 34 are not open. Thus, second ultrasonic sensor 304 does not see broadcast pulses 322b and 322c (represented as potential interferences 306b and 306c in FIG. 3).

FIG. 3 thus demonstrates how second ultrasonic sensor 304 is viewing the broadcast pulses of first ultrasonic sensor 302 as interference 306. FIG. 3 shows that first broadcast pulse of first ultrasonic sensor 302 is viewed by second ultrasonic sensor 304 in its sensor first receive window 334a shortly after t₁. This interference is represented as 306a. Because of the random time intervals of the pulse emissions of both sensors 302 and 304, the other two potential interferences 306b and 306c are not received within a receive window of second ultrasonic sensor 304. Accordingly, the received interfering pulse 306a is more likely to be recognized as an outlier based on differing characteristics than typical objects. For example, because ultrasonic broadcasts are typically sent at rate much more frequent than movement of typical objects that are detected by the ultrasonic sensor, even a fast moving object should appear over multiple consecutive receive windows. These patterns and characteristics may be utilized to filter out interfering signals. As one example, a median filter 340 removes the outlier signal 350 (first broadcast pulse of first ultrasonic third sensor 302) creating interference 306a (shown as 360), whereas a signal representing actual motion would typically not be removed by such a filter.

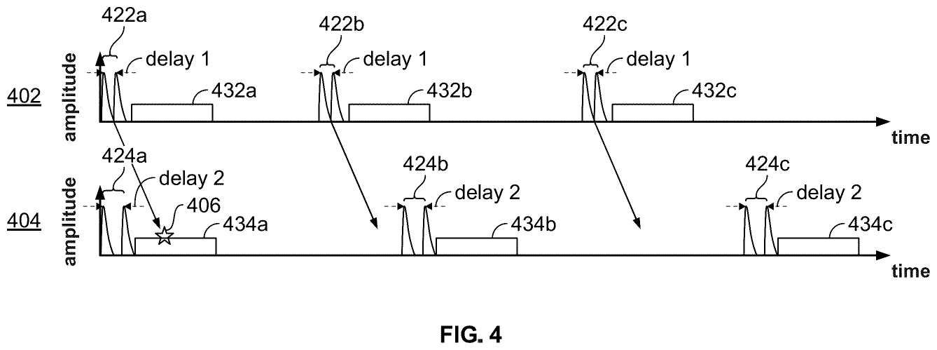

FIG. 4 depicts an illustrative object detection system with programmable delays of ultrasonic transmissions in accordance with an embodiment of the present disclosure. FIG. 4 shows exemplary broadcast pulses, receive windows, and receive timing of potential interfering signals for a first ultrasonic sensor 402 and a second ultrasonic sensor 404 on a common time scale. It will be understood that the particular timing and number of ultrasonic sensors is for illustration only and that in accordance with the present disclosure numerous ultrasonic sensors (e.g., 3, 4, 10, dozens, etc.) may be located within an area in which signals may potentially interfere, e.g., may be received by other ultrasonic sensors. In the exemplary embodiment of FIG. 4, each of the sensors has a programmable (e.g., selectable or changeable) delay between broadcasts (e.g., having a particular predetermined period or frequency). Further, information about the delay is encoded within the pattern of the broadcast pulses. In the embodiment depicted in FIG. 4, the delay between broadcasts is encoded via a delay between the broadcast pulses, although encoding may be performed in a variety of additional manners, for example, based on pulse amplitudes, duty cycles, number of pulses, pulse delays, and combinations thereof.

In the example depicted in FIG. 4, First ultrasonic sensor 402 emits a broadcast pulse train having a first delay 422 (i.e., first ultrasonic sensor 402 emits a first pulse train have a first delay 422a at time equals 0, first ultrasonic sensor 402 emits a second pulse train with a first delay 422b at time equals 0+1n, and first ultrasonic sensor 402 emits a third pulse train with a first delay 422c at time equals 0+2n). An example broadcast pulse train is two broadcast pulses in succession wherein there is a specific time delay between the two pulses. There are multiple delays used between the two broadcast pulses wherein each delay is a predefined measurement rate. Each delay corresponds to a different channel or can also be referred to as an encoded identifier. In the current example, Channel 1 has a measurement rate of 115 ms (time of 115 ms between the two broadcast pulses) and is referred to as code first delay. Channel 2 has a measurement rate of 130 ms (time of 130 ms between the two broadcast pulses) and is referred to code second delay. Channel 3 has a measurement rate of 145 ms (time of 140 ms between two broadcast pulses) and is referred to as code third delay. Channel 4 is a measurement rate of 160 ms (time of 160 ms between the two broadcast pulses) and is a referred to a code delay 4. In this example, each channel has delay times in increments of 15 ms. The particular channels, and their broadcast characteristics, can be selected in a manner to decrease the potential for interference between channels, based on underlying factors such as number of channels, timing of receive windows, expected reflection characteristics of types of objects being sensed, and other similar factors. For example, the number of channels can be related to the measurement rate and duration of sound reverberation (e.g., sound at lower frequencies travels a longer distance than higher frequencies, and therefore, reverberation can be longer). The increments of the delay times (e.g., 10 ms, 15 ms, 20 ms, etc.) can be selected based on the sound reverberation such that a sensor noise level is below a desired value.

First ultrasonic sensor 402 has a sensor receive window 432 that opens after a broadcast pulse train 422 is emitted (i.e., sensor first receive window 432a opens after the first pulse train 422a is emitted, sensor second receive window 432b opens after the second pulse train 422b is emitted and sensor third receive window 432c opens after the third pulse train 422c is emitted.) Second ultrasonic sensor 404 emits a broadcast pulse train having a second delay 424 (i.e., second ultrasonic sensor 404 emits a broadcast first pulse train having a second delay 424a, second ultrasonic sensor 404 emits a broadcast second pulse train having a second delay 424b and second ultrasonic sensor 404 emits a broadcast third pulse train having a second delay 424c). In this embodiment second delay is equal to 130 ms. This delay is the time between the two pulses emitted by second ultrasonic sensor 404 in succession. Second delay is 15 ms longer in time than first delay, a 15 ms difference. Second ultrasonic sensor 404 has a sensor first receive window 434 that opens after a pulse train 424 is emitted (i.e., sensor first receive window 434a opens after the first pulse train 424a is emitted, sensor second receive window 434b opens after the second pulse train 424b is emitted, and sensor third receive window 434c opens after the third pulse train 424c is emitted).

FIG. 4 further shows the broadcast first pulse train of first ultrasonic sensor 422a at it is received by the first receive window 434a of second ultrasonic sensor 404 as interference 406. Broadcast first pulse train of first ultrasonic sensor 422a is broadcast by first ultrasonic sensor 402 such that it is received at second ultrasonic sensor 404 at a time when the first receive window 434a of second ultrasonic sensor 404 is open. Thus, second ultrasonic sensor 404 receives this broadcast first pulse train 422a as interference 406. Because of the selected time intervals of the train pulses of both sensors 402 and 404, both broadcast second pulse train 422b of first ultrasonic sensor 402 and broadcast third pulse train 422c of first ultrasonic sensor 402 are emitted at times when they will not be received during the corresponding sensor receive windows 434b, 434c of second ultrasonic sensor. Thus, second ultrasonic sensor 404 does not receive broadcast pulse trains 422b and 422c and the received interfering signal 406 can be readily identified as interference and filtered or otherwise removed/discarded.

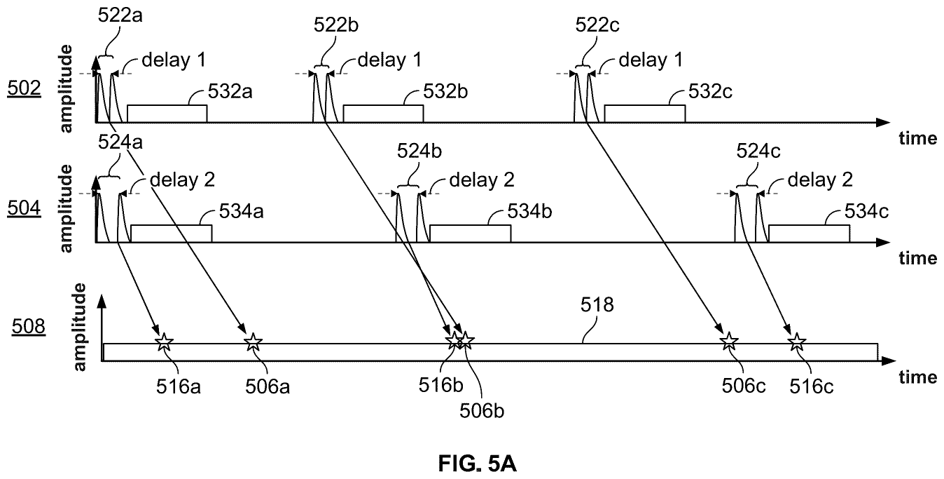

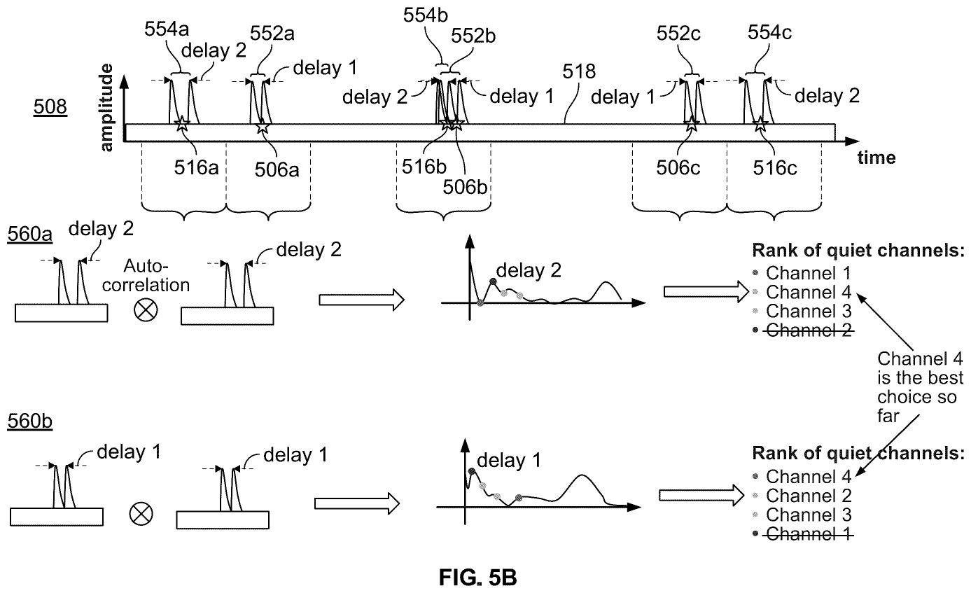

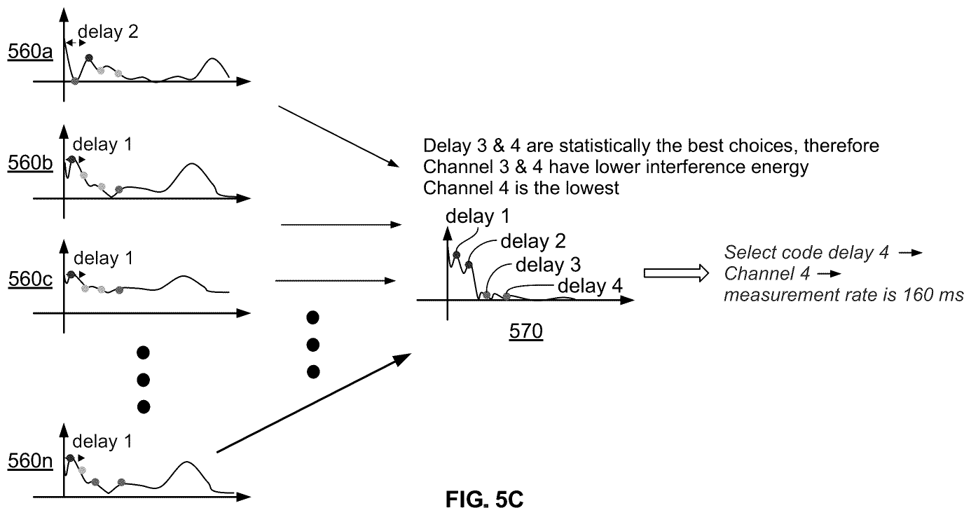

FIG. 5A depicts an illustrative object detection system with ultrasonic sensors wherein a sensor monitors transmissions to join a network of sensors in accordance with an embodiment of the present disclosure. As described for FIG. 4, multiple ultrasonic sensors may select channels having encoded delays (e.g., corresponding to a period and frequency) between broadcast pulse trains (e.g., encoded as a delay between individual pulses). Ultrasonic sensors may engage in a monitoring or setup routine such as when they are first introduced to a new area of interest, periodically or at predetermined times during operation, and/or in response to occurrence of some condition such as periods of significant interference or user selections. During the monitoring or setup period, an ultrasonic sensor opens a receive window for an extended period of time such that it can receive multiple broadcasts from multiple other ultrasonic sensors (e.g., the receive window is open long enough to receive multiple broadcasts over multiple periods in accordance with known or expected broadcast channel characteristics). The receiving ultrasonic sensor (e.g., third ultrasonic sensor 506 in FIG. 5) can then use information about the received broadcasts such as signal strength, signal timing, and encoded channel information to identify which channels are already being utilized within the area of interest, and in some embodiments, the respective timing (e.g., phase) of those broadcasts. The ultrasonic sensor in the monitoring or setup mode can then select the appropriate broadcast signal characteristics (e.g., channel, timing, filtering techniques, etc.) to minimize interference when it is operational in the area of interest.

In an example, FIG. 5A shows a first ultrasonic sensor 502, a second ultrasonic sensor 504, and a third sensor 508. First ultrasonic sensor 502 emits a broadcast pulse train having a first delay 522 (i.e., first ultrasonic sensor 502 emits a first pulse train having a first delay 522a at time equals 0, first ultrasonic sensor 502 emits a second pulse train with a first delay 522b at time equals 0+1n, and first ultrasonic sensor 502 emits a third pulse train with a first delay 522c at time equals 0+2n). A broadcast pulse train is two broadcast pulses in succession wherein there is a specific time delay between the two pulses. There are multiple delays used between the two broadcast pulses wherein each delay is a predefined measurement rate. Each delay corresponds to a different channel. In the current example, Channel 1 has a measurement rate of 115 ms (time of 115 ms between the two broadcast pulses) and is referred to as code first delay. Channel 2 has a measurement rate of 130 ms and is referred to as code second delay. Channel 3 has a measurement rate of 145 ms and is referred to as code third delay. Channel 4 has a measurement rate of 160 ms and is a referred to a code delay 4. In this example, each channel has delay times in increments of 15 ms. Any increment amount can be used as long as the increment amount of time between the channels remains constant.

First ultrasonic sensor 502 has a sensor receive window 532 that opens after a pulse train 522 is emitted (i.e., sensor first receive window 532a opens after the first pulse train 522a is emitted, sensor second receive window 532b opens after the second pulse train 522b is emitted and sensor third receive window 532c opens after the third pulse train 522c is emitted.)

Second ultrasonic sensor 504 emits a broadcast pulse train having a second delay 524 (i.e., second ultrasonic sensor 504 emits a broadcast first pulse train having a second delay 524a, second ultrasonic sensor 504 emits a broadcast second pulse train having a second delay 524b and second ultrasonic sensor 504 emits a broadcast third pulse train having a second delay 524c). In this embodiment second delay is equal to 130 ms and also referred to as channel 2. This delay is the time between the two pulses emitted by second ultrasonic sensor 504 in quick succession. Second delay is 15 ms longer in time than first delay, a 15 ms difference. Second ultrasonic sensor 504 has a sensor first receive window 534 that opens after a pulse train 524 is emitted (i.e., sensor first receive window 534a opens after the first pulse train 524a is emitted, sensor second receive window 534b opens after the second pulse train 524b is emitted and, sensor third receive window 534c opens after the third pulse train 524c is emitted).

FIG. 5A shows third sensor 508 which activates and opens its sensor receive window 518 in a listening mode for other ultrasonic sensors. While its sensor receive window 518 is open it starts to receive the multiple pulse train delays emitted by both first ultrasonic sensor 502 and second ultrasonic sensor 504. More specifically, third sensor sees three broadcasts from first ultrasonic sensor 506 and three broadcasts from second ultrasonic sensor 516. First ultrasonic sensor 502 emits first pulse train having a first delay 522a which is shown as broadcast 506a on third sensor receive window 518. First ultrasonic sensor 502 emits second pulse train having a first delay 522b which is shown as broadcast 506b on third sensor receive window 518. First ultrasonic sensor 502 emits third pulse train having a first delay 522c which is shown as broadcast 506c on third sensor receive window 518. Similarly, second ultrasonic sensor 504 emits first pulse train having a second delay 524a which is shown as broadcast 516a on third sensor 508. Second ultrasonic sensor 504 emits second pulse train having a second delay 524b which is shown as broadcast 516b on third sensor receive window 518. Second ultrasonic sensor 504 emits third pulse train having a second delay 524c which is shown as broadcast 516c on third sensor receive window 518.

When looking at the sensor receive window of third sensor 518, there are multiple received broadcasts 506 and 516 that are received by third sensor 508 over time. Sometimes, based on the selected delays of the broadcasting ultrasonic sensors, the broadcasts are received by third sensor 508 in their own distinct time frame (i.e., broadcasts 516a, 506a, 506c, and 516c) and in other instances the broadcasts overlap as they are received by third sensor 508 (i.e., broadcasts 516b and 506b). Third sensor 508 utilizes the received signals to determine what channels and associated delays are associated with each other sensor within the area of interest.

FIGS. 5B and 5C depict a sensor utilizing the monitoring to determine availability of ultrasonic transmission channels in accordance with an embodiment of the present disclosure. Third sensor 508 then further decides what is the optimal channel for it to use with the least amount of interference. Third sensor 508 reads the various interferences it receives in its sensor receive window 518 to determine which delay channels are currently in use by first ultrasonic sensor 502 and second ultrasonic sensor 504. FIG. 5B shows the third sensor 508 receive window 518 during which it receives broadcast signals from first ultrasonic sensor 502 and second ultrasonic sensor 504. in order to listen to any broadcast pulse trains emitted by sensors in use. Starting at time equals 0, the first broadcast pulse train read by the sensor 508 is broadcast first pulse train 554a having a second delay from second ultrasonic sensor 504 which is shown as interference 516a. Next, third sensor 508 reads broadcast first pulse train 552a having a first delay from first ultrasonic sensor 502 which is shown as interference 506a. Next, third sensor 508 reads both broadcast second pulse train having a second delay 554b from second ultrasonic sensor 504 and broadcast second pulse train 552b having a first delay from first ultrasonic sensor 502 concurrently shown as interferences 516b and 506b respectively, based on those being received at about the same time and interfering with each other at the third sensor 508. Third, third sensor 508 reads broadcast third pulse train 552c having a first delay from first ultrasonic sensor 502 shown as interference 506c. Finally, third sensor 508 reads broadcast third pulse train 554c having a second delay from second ultrasonic sensor 504 shown as interference 516c.

Third sensor 508 is able to read the four interferences that are occurring independently (516a, 506a 506c, and 516c) and utilize that information to determine the delays (e.g., period between broadcast pulse trains/frequency of the broadcast pulse trains) of these four broadcast pulse trains. In an example, auto-correlation is used to determine the frequency of occurrence of the delays of the pulse trains. Because the autocorrelation of a long vector of data requires high computational capacity, different sections of data are selected and autocorrelated to determine the different delays or channels being used. FIG. 5B shows a first slice of data in time along the sensor receive window 518 being autocorrelated 560a. In the section 560a, an autocorrelation value at a timing associated with a broadcast pulse with a second known channel is the most dominant. The channels are ranked from channel 2 having the highest autocorrelation value, followed by channel 3, channel 4 and channel 1. In a second slice of data in time along the sensor receive window 518 that is being autocorrelated 560b, the autocorrelation value is highest at a timing associated with a first delay corresponding to a first channel. The delays associated with other channels are ranked with channel 1 having the highest autocorrelation value, followed by channel 3, channel 2 and channel 4.

FIG. 5C shows how this data is further evaluated and autocorrelated to select the channel with the lowest interference probability given the lowest correlation factor. The process depicted in FIG. 5B is repeated multiple (e.g., “n”) times based on the monitoring time used during the channel monitoring operation. As is depicted in FIG. 5C, the autocorrelation 560a-560n is performed for each of the received portions of data and the results are aggregated as depicted at aggregated autocorrelations 570. As can be seen from the aggregated autocorrelations, the channel with the least likelihood of interference is channel 4, although channel 3 would also be satisfactory. Based on these results, the third ultrasonic sensor 508 can select its channel and “join” the network of ultrasonic sensors, while implementing any appropriate strategies to mitigate interference based on the other known channels of the network.

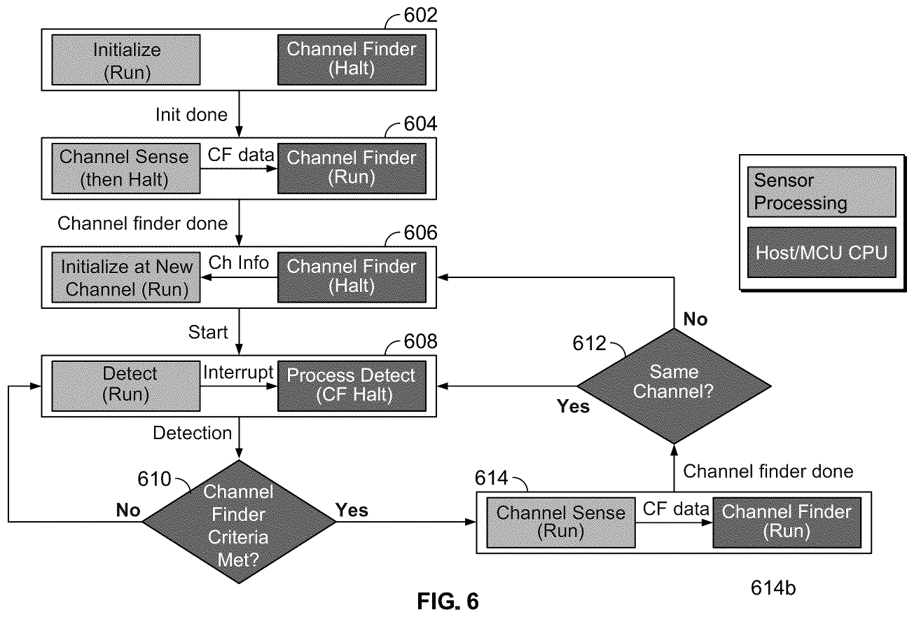

FIG. 6 depicts exemplary steps of ultrasonic channel autoconfiguration in accordance with an embodiment of the present disclosure. Although a particular set of steps are depicted in FIG. 6 in a particular order, it will be understood that steps may be added or removed, and that the order of steps may be modified in some embodiments. In the example of FIG. 6, certain operations are depicted as performed by a host computing unit (e.g., a Host/MCU CPU type processing circuitry) while other operations are depicted as performed locally by the sensor processing unit (e.g., a microprocessor, ASIC, and/or FPGA). It will be understood that the processing described in FIG. 6 and elsewhere herein may be split between processing circuitry in any suitable manner, that processing circuitry may include additional processing units, and/or processing circuitry may be combined. Generally, the Host CPU performs higher level processing operations and may often be in a sleep or standby mode, while the sensor processing circuitry consumes less power and is generally awake (or awake more often) to perform initial monitoring, passing data to the Host CPU for higher computational load operations.

At step 602, the sensor processing circuitry of the sensor is turned on or initialized 602a and begins to receive initial data of any broadcast pulses being emitted from any sensors. Once the sensor is initialized, processing continues to step 604.

At step 604, the sensor processing circuitry of the sensor performs channel finding operations (e.g., as described herein such as in FIGS. 5A-5) by opening a receive window to monitor received signals (e.g., without broadcasts) from broadcasts of other ultrasonic signals. The received signal data (e.g., timing and amplitude of data points corresponding to received broadcast pulse trains from other ultrasonic sensors) is provided to the Host CPU to identify a channel that may be utilized by the sensor while minimizing interference with other ultrasonic sensors. Once the channel is selected, processing continues to step 606.

At step 606, the Host CPU provides the selected channel information to the sensor processing circuitry such that the ultrasonic sensor can operate its broadcasts and receive times in accordance with the selected channel, as well as perform other mitigating operations such as occasional staggering of transmission times, filtering, and the like. Once the sensor is initialized to operate in accordance with the selected channel, processing continues to step 608.

At step 608, once the ultrasonic sensor pulse train channel is set, it continues to run until an event occurs that requires analysis by the Host CPU (e.g., by providing an interrupt to wake the Host CPU), such as receipt of multiple pulses likely corresponding to motion or receipt of a signal that may correspond to interference. Once an interrupt is provided to the Host CPU, processing continues to step 610.

At step 610, the Host CPU may analyze the receive data to determine whether the channel finder routine should be run again, for example, due to a likelihood of interference such as from a new ultrasonic sensor in the environment or an ultrasonic sensor that was not active during the initial channel finder step. If a further channel finder step is required, processing returns to step 608. If another channel finder step is required, processing continues to step 612 to perform the channel finder operation (e.g., as performed in step 604) again. Once the channel is selected at step 612, processing continues to step 614, where the Host CPU determines whether the selected channel from step 612 is the same channel that was initially or previously selected. If it is the same channel, processing returns to step 608 and operation of the ultrasonic sensor continues normally. If it is not the same channel, processing returns to step 606 to initialize the ultrasonic sensor to the new channel.

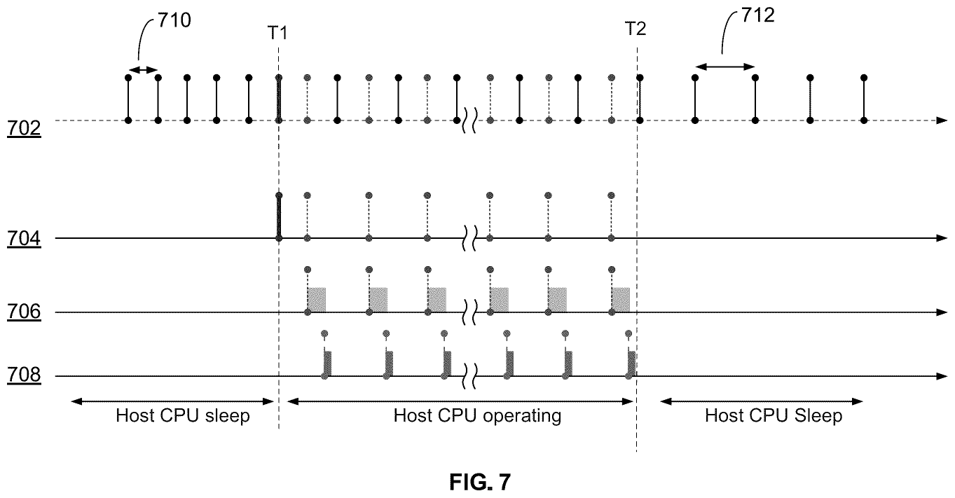

FIG. 7 depicts an exemplary sequence of signals for ultrasonic channel configuration in accordance with an embodiment of the present disclosure. It will be understood that FIG. 7 shows a particular sequence and manner of operation in accordance with a particular example, and that this sequence and manner of operation may be modified in other examples. In the example of FIG. 7, broadcast sequence 702 corresponds to broadcasts from an ultrasonic sensor, interrupt 704 corresponds to interrupts provided from a sensor processing unit to a Host CPU, receive window data collection 706 corresponds to time periods during which the ultrasonic sensor is in a monitoring mode with an open receive window, and channel finder 708 corresponds to time periods during which the Host CPU executes the channel finder algorithm to select a channel.

As is depicted for broadcast sequence 702 prior to time T1, initially the ultrasonic sensor is broadcasting pulse trains (each illustrated as a single solid line pulse for simplicity in FIG. 7) at a frequency corresponding to period 710, which in turn is associated with a broadcast channel. By time T1, the ultrasonic sensor local processing identifies a condition where there may be interference that requires running the channel finder routine, and provides an interrupt (dark black line) at interrupt 704 to the Host CPU. The host CPU then wakes up to perform the channel finder routine.

During the channel finder routine, between time T1 and time T2, the ultrasonic sensor continues to operate on its existing channel but alternates between normal broadcast and receive operation (solid lines in broadcast sequence 702) and monitoring operations for the channel finder routine (dashed lines in broadcast sequence 702). As is depicted during receive window data collection 706 by dashed lines and rectangular receive window, and corresponding to the monitoring operations of broadcast sequence 702, the ultrasonic sensor monitors for received broadcast signals over a period of time. Data regarding received broadcast signals during each monitoring period are provided to the Host CPU, for channel detection as depicted by the lines and shaded rectangle in channel finder 708. As depicted in FIG. 7, multiple cycles of receive window data collection 706 and channel finder 708 are performed until a new channel is identified, as depicted at time T2. The ultrasonic sensor then broadcasts pulse trains (each illustrated as a single solid line pulse for simplicity in FIG. 7 after T2) at a frequency corresponding to period 712, which in turn is associated with the new broadcast channel.

The foregoing description includes exemplary embodiments in accordance with the present disclosure. These examples are provided for purposes of illustration only, and not for purposes of limitation. It will be understood that the present disclosure may be implemented in forms different from those explicitly described and depicted herein and that various adaptations, optimizations, and variations may be implemented by a person of ordinary skill in the present art, consistent with the following claims.

What is claimed is:

1. A method of operating an ultrasonic sensor within a multi-sensor environment, comprising:
broadcasting, by the ultrasonic sensor, a first ultrasonic signal at each of a plurality of broadcast times, wherein the first ultrasonic signal includes a first encoded identifier;
receiving, by the ultrasonic sensor, received ultrasonic signals during a plurality of receive windows, wherein each receive window of the plurality of receive windows follows a respective broadcast time of the plurality of broadcast times;
identifying a second ultrasonic signal from the received ultrasonic signals based on a respective timing of the second ultrasonic signal and the first ultrasonic signal, wherein the second ultrasonic signal includes a second encoded identifier, and wherein the respective timing is based on a first timing of broadcasts of the first ultrasonic signal indicated by the first identifier and a second timing of broadcasts of the second ultrasonic signal indicated by the second identifier; and
monitoring an object within a field of view of the ultrasonic signal based on a subset of the received ultrasonic signals that does not include the second ultrasonic signal.

2. The method of claim 1, further comprising removing the second ultrasonic signal from the monitoring with a median filter.

3. The method of claim 1, wherein, based on the respective timing, the second ultrasonic signal is only received within one receive window of the plurality of receive windows.

4. The method of claim 3, wherein the plurality of receive windows comprise three or more consecutive receive windows associated with three or more respective broadcast times of the ultrasonic signal.

5. The method of claim 1, wherein the first encoded identifier corresponds to a first broadcast period between transmissions of the first ultrasonic signal and the second encoded identifier corresponds to a second broadcast period between transmissions of second ultrasonic signal.

6. The method of claim 5, wherein the first broadcast period corresponds to a first channel of a plurality of channels and the second broadcast period corresponds to a second channel of the plurality of channels.

7. The method of claim 6, wherein the plurality of channels further comprise a third channel having a third broadcast period different from the first broadcast period and the second broadcast period and a fourth channel having a fourth broadcast period different from the first broadcast period, the second broadcast period, and the fourth broadcast period.

8. The method of claim 7, wherein the first broadcast period, the second broadcast period, the third broadcast period, and the fourth broadcast period are selected such that the ultrasonic sensor is capable of removing interfering signals broadcasted at each of the second broadcast period, the third broadcast period, and the fourth broadcast period.

9. The method of claim 6, wherein the first channel and the second channel are included within a plurality of channels, and wherein each channel of the plurality of channels is associated with a distinct broadcast period.

10. The method of claim 5, further comprising, before broadcasting the ultrasonic signal at the first broadcast period:
monitoring for ultrasonic transmissions;
identifying the second ultrasonic signal based on the second encoded identifier; and
selecting the first broadcast period based at least in part on the identification of the second ultrasonic signal.

11. The method of claim 10, further comprising:
identifying a third ultrasonic signal based on a third encoded identifier, wherein the third encoded identifier corresponds to a third broadcast period between transmissions of the third ultrasonic interfering signal; and
selecting the first broadcast period based at least in part on the identification of the second ultrasonic signal and the third interfering signal.

12. The method of claim 11, further comprising autocorrelating the monitored ultrasonic transmissions, wherein the identifying of the second ultrasonic signal and the third ultrasonic signal is based on the autocorrelation.

13. The method of claim 1, wherein an encoding for each of the first encoded identifier and the second encoded identifier is based on a pulse pattern of each of the first ultrasonic signal and the second ultrasonic signal.

14. The method of claim 13, wherein the pulse pattern comprises a period between consecutive pulses.

15. The method of claim 14, wherein a respective broadcast period for each of the first ultrasonic signal and the second ultrasonic signal is based on a multiplication of a value with a respective period of the pulse pattern of each of the first ultrasonic signal and the second ultrasonic signal.

16. The method of claim 13, wherein the pulse pattern comprises one of a difference in pulse amplitudes, a duty cycle, or a pulse width.

17. A method of operating an ultrasonic sensor within a multi-sensor environment, comprising:
monitoring, by a first ultrasonic sensor, for received ultrasonic signals;
identifying, from the received ultrasonic signals, a plurality of broadcasts from a plurality of additional ultrasonic sensors;
determining, from the received ultrasonic signals, a subset of occupied channels of a plurality of broadcast channels, wherein each channel of the plurality of broadcast channels is associated with a unique fixed delay between broadcasts; and
selecting, based on the subset of occupied channels, another of the broadcast channels for the first ultrasonic signal; and
broadcasting ultrasonic signals from the first ultrasonic in accordance with the selected broadcast channel.

18. The method of claim 17, wherein the identifying comprises autocorrelating the received ultrasonic signals.

19. The method of claim 17, wherein, for each ultrasonic sensor of the plurality of additional ultrasonic sensors, the unique fixed delay is encoded in a respective broadcast signal of the ultrasonic sensor.

20. An ultrasonic sensor configured to operate within a multi-sensor environment, comprising:
a transceiver configured to broadcast and receive ultrasonic signals;
processing circuitry coupled to the transceiver, wherein the processing circuitry is configured to:
broadcast, via the transceiver, a first ultrasonic signal at each of a plurality of broadcast times, wherein the first ultrasonic signal includes a first encoded identifier;
receive, via the transceiver, received ultrasonic signals during a plurality of receive windows, wherein each receive window of the plurality of receive windows follows a respective broadcast time of the plurality of broadcast times;
identify a second ultrasonic signal from the received ultrasonic signals based on a respective timing of the second ultrasonic signal and the first ultrasonic signal, wherein the second ultrasonic signal includes a second encoded identifier, and wherein the respective timing is based on a first timing of broadcasts of the first ultrasonic signal indicated by the first identifier and a second timing of broadcasts of the second ultrasonic signal indicated by the second identifier; and
monitor an object within a field of view of the ultrasonic signal based on a subset of the received ultrasonic signals that does not include the second ultrasonic signal.
